(19) United States
(12) Patent Application Publication
(10) Pub. No.: US 2025/0208275 A1
(43) Pub. Date: Jun. 26, 2025

(54) METHOD FOR THE CALIBRATION OF ULTRASONIC SENSORS OF AN ULTRASONIC -SENSOR ROW AND VEHICLE

(71) Applicant: Robert Bosch GmbH, Stuttgart (DE)

(72) Inventors: Michael Schumann, Stuttgart (DE); Lena Bendfeld, Stuttgart (DE); Nicolas Leteinturier, Leonberg (DE)

(21) Appl. No.: 18/986,961

(22) Filed: Dec. 19, 2024

(30) Foreign Application Priority Data
Dec. 20, 2023 (DE) 10 2023 213 116.1

(51) Int. Cl. G01S 7/52; G01S 7/539; G01S 15/46; G01S 15/931

(52) U.S. Cl. CPC G01S 7/52004; G01S 7/539; G01S 15/46; G01S 15/931; G01S 2015/465

(57) ABSTRACT

A method for the calibration of ultrasonic sensors of an ultrasonic-sensor row.

### FIELD

The present invention relates to a method for the calibration of ultrasonic sensors of an ultrasonic-sensor row and to a vehicle.

### BACKGROUND INFORMATION

Vehicles often have ultrasound-based driver assistance systems, in particular in the form of ultrasound-based parking aids, having several, for example 4, 5, 6 or 8, ultrasonic sensors, which are arranged on the vehicle to form an ultrasonic-sensor row.

A typical ultrasonic sensor of an ultrasound-based parking aid emits an ultrasonic pulse, which is reflected by an object as an echo. The echo can be detected by the ultrasonic sensor, and a distance between the ultrasonic sensor and the object can be ascertained on the basis of a duration of a time period between the emission of the ultrasonic pulse and the receiving of the echo. In addition, the ultrasonic sensor can detect the incident elevation angle and azimuth angle of the echo.

### SUMMARY

An object of the present invention is to provide a method for the calibration of ultrasonic sensors of an ultrasonic-sensor row which enables calibration of the ultrasonic sensors with a high degree of accuracy. The object of the present invention is also to provide a vehicle which is designed to carry out the method.

The object of the present invention is achieved by a method and by a vehicle having certain features of the present invention. Advantageous developments of the present invention are disclosed herein.

A method according to the present invention is suitable for calibrating ultrasonic sensors of an ultrasonic-sensor row, in particular for the measurement of an azimuth angle. The ultrasonic-sensor row comprises a first ultrasonic sensor and a second ultrasonic sensor. According to an example embodiment of the present invention, the method comprises the steps of: a) detecting an echo of an ultrasonic pulse from an object by means of the first ultrasonic sensor, the detecting of the echo by means of the first ultrasonic sensor comprising detection of an azimuth angle of the echo; b) detecting the echo of the ultrasonic pulse from the object by means of the second ultrasonic sensor, the detecting of the echo by means of the second ultrasonic sensor comprising detection of an azimuth angle of the echo; c) ascertaining a target azimuth angle of the echo for the first ultrasonic sensor and a target azimuth angle of the echo for the second ultrasonic sensor on the basis of a position determination of the object by trilateration; d) ascertaining a correction value for the detecting of the azimuth angle by means of the first ultrasonic sensor on the basis of the ascertained target azimuth angle of the echo for the first ultrasonic sensor; e) ascertaining a correction value for the detecting of the azimuth angle by means of the second ultrasonic sensor on the basis of the ascertained target azimuth angle of the echo for the second ultrasonic sensor.

Advantageously, the trilateration can be used to calibrate the ultrasonic sensors for the measurement of an azimuth angle with a particularly high degree of accuracy. The ultrasonic sensors can be calibrated by ascertaining the correction values for the measuring of azimuth angles by means of the ultrasonic sensors. After the calibration, azimuth angles of further echoes can be detected by means of the ultrasonic sensors particularly precisely using the correction values.

A further aspect of the present invention is that the method can be carried out during use of the ultrasonic sensors in an application.

A distance between the first ultrasonic sensor and the second ultrasonic sensor can be specified.

The first ultrasonic sensor and the second ultrasonic sensor can be mutually adjacent ultrasonic sensors.

According to an example embodiment of the present invention, the method can comprise, before step a), the step of: p) emitting an ultrasonic pulse by means of the first ultrasonic sensor. The echo detected in step a) can be a direct echo. A direct echo can be an echo detected by the ultrasonic sensor that emitted the ultrasonic pulse. The echo detected in step b) can be a cross echo. A cross echo can be an echo detected by an ultrasonic sensor that did not emit the ultrasonic pulse.

According to an example embodiment of the present invention, detecting the echo in step a) can comprise recording a duration of a time period between emission of the ultrasonic pulse and the receiving of the echo by means of the first ultrasonic sensor.

According to an example embodiment of the present invention, detecting the echo in step b) can comprise recording a duration of a time period between emission of the ultrasonic pulse and the receiving of the echo by means of the second ultrasonic sensor.

According to an example embodiment of the present invention, the method can comprise the steps of: q) ascertaining a distance of the object from the first ultrasonic sensor on the basis of the echo detected by means of the first ultrasonic sensor; and r) ascertaining a distance of the object from the second ultrasonic sensor on the basis of the echo detected by means of the second ultrasonic sensor. The ascertainment of the distance in step q) can be based on the recorded duration of the time period between the emission of the ultrasonic pulse and the receiving of the echo by means of the first ultrasonic sensor. The ascertainment of the distance in step r) can be based on the recorded duration of the time period between the emission of the ultrasonic pulse and the receiving of the echo by means of the second ultrasonic sensor.

The position determination of the object by trilateration in step c) can be based on the distance ascertained in step q) and the distance ascertained in step r). In addition, the position determination of the object by trilateration in step c) can be based on the specified distance between the first ultrasonic sensor and the second ultrasonic sensor.

The object can be, for example, a lamppost, a pole, or a wall.

The echo detected by means of the first ultrasonic sensor and the echo detected by means of the second ultrasonic sensor can each be an echo of the same ultrasonic pulse or of different ultrasonic pulses.

According to an example embodiment of the present invention, a sensor range of the first ultrasonic sensor and/or a sensor range of the second ultrasonic sensor can be divided into angular intervals. The correction values for the detecting of the azimuth angle by means of the first ultrasonic sensor and/or the correction values for the detecting of the azimuth angle by means of the second ultrasonic sensor can be ascertained separately for each angular interval.

According to an example embodiment of the present invention, after the method has been carried out, the first ultrasonic sensor can detect an azimuth angle of an echo, the detected azimuth angle being corrected by the correction value ascertained in step d). After the method has been carried out, the second ultrasonic sensor can detect an azimuth angle of an echo, the detected azimuth angle being corrected by the correction value ascertained in step e). Advantageously, azimuth angles can thus be detected more precisely by means of the first ultrasonic sensor and/or by means of the second ultrasonic sensor.

In a development of the method of the present invention, the method comprises the step of: f) ascertaining a reflection characteristic of the object in an azimuthal plane of the ultrasonic sensors on the basis of the echo detected by means of the first ultrasonic sensor and the echo detected by means of the second ultrasonic sensor. At least steps d) and e) are carried out if a punctiform or linear reflection characteristic is ascertained in step f). At least steps d) and e) are not carried out if a punctiform or linear reflection characteristic is not ascertained in step f). Advantageously, by using echoes which originate from entities having a punctiform or linear reflection characteristic for the calibrating of the ultrasonic sensors, the correction values can be ascertained particularly precisely.

For example, a lamppost or a pole can have a punctiform reflection characteristic in the azimuthal plane of the ultrasonic sensors. For example, a wall can have a linear reflection characteristic in the azimuthal plane of the ultrasonic sensors.

An object that has a punctiform reflection characteristic in the azimuthal plane of the ultrasonic sensors can be called a punctiform object. An object that has a linear reflection characteristic in the azimuthal plane of the ultrasonic sensors can be called a linear object.

The ascertainment of the reflection characteristic in step f) can be accomplished by comparing echo lengths in successive cycles for different model assumptions.

According to an example embodiment, at least steps d) and e) cannot be carried out if a linear reflection characteristic is ascertained in step f) and the object is located at a distance of more than 1 m (meter) from the first ultrasonic sensor and/or from the second ultrasonic sensor.

In a development of the method of the present invention, the method comprises the step of: g) ascertaining a reflection characteristic of the object on the basis of a history of echoes detected by means of the first ultrasonic sensor and on the basis of a history of echoes detected by means of the second ultrasonic sensor. At least steps d) and e) are carried out if a multi-reflective reflection characteristic is not ascertained in step g), and at least steps d) and e) are not carried out if a multi-reflective reflection characteristic is ascertained in step g). Advantageously, this can prevent the method from being carried out on the basis of echoes originating from entities having a multi-reflective reflection characteristic. This can avoid ambiguities in the position determination of the object by trilateration.

The multi-reflective reflection characteristic can be ascertained on the basis of the echo structure. In other words, the multi-reflective reflection characteristic can be ascertained on the basis of the existence of a relatively large number of echoes following one another in time or on the basis of an increased pulse width of the echoes. The ascertainment of the reflection characteristic in step g) can be accomplished using statistical methods.

In a development of the method of the present invention, the method comprises the step of: h) analyzing the echo detected by means of the first ultrasonic sensor and/or analyzing the echo detected by means of the second ultrasonic sensor as to whether a disturbance is present. At least steps d) and e) are carried out if a disturbance is not ascertained in step h). At least steps d) and e) are not carried out if a disturbance is ascertained in step h). Advantageously, this can prevent incorrect ascertainment of the correction values.

A disturbance can be present if the echo detected by means of the first ultrasonic sensor and/or the echo detected by means of the second ultrasonic sensor contains noise and/or is superposed with an echo from a base surface or ground.

In a development of the method of the present invention, the method comprises the step of: i) analyzing the position determination of the object of step c) as to whether the object is within a specified permissible range. At least steps d) and e) are carried out if the analysis of step i) shows that the object is within the specified permissible range. At least steps d) and e) are not carried out if the analysis of step i) shows that the object is outside the specified permissible range.

The permissible range can be a range in which an object can be positioned and the echo can be reliably detected by means of the first ultrasonic sensor in step a) and the echo can be reliably detected by means of the second ultrasonic sensor in step b).

In a development of the method of the present invention, the correction value is ascertained in step d) by subtracting the azimuth angle of the echo that was detected by means of the first ultrasonic sensor from the target azimuth angle of the echo for the first ultrasonic sensor. The correction value is ascertained in step e) by subtracting the azimuth angle of the echo that was detected by means of the second ultrasonic sensor from the target azimuth angle of the echo for the second ultrasonic sensor.

In a development of the method of the present invention, at least steps a) to e) are carried out several times. The correction value is ascertained in step d) by calculating a median value or a mean of differences between the azimuth angles of the echoes that were detected by means of the first ultrasonic sensor and the target azimuth angles of the echoes for the first ultrasonic sensor. The correction value is ascertained in step e) by calculating a median value or a mean of differences between the azimuth angles of the echoes that were detected by means of the second ultrasonic sensor and the target azimuth angles of the echoes for the second ultrasonic sensor.

The mean of the differences can be a weighted mean. The weighted mean of the differences can be calculated by giving older differences a lower weight than newer differences.

In a development of the method of the present invention, the method comprises the steps of: k) detecting a temperature while at least one of steps a) to e) is being carried out, and m) storing the correction values ascertained in steps d) and e) and the temperature detected in step k). The correction values ascertained in steps d) and e) can be temperature-dependent. When the ultrasonic sensors are put into operation or after a reset, a temperature can be measured and the correction values corresponding to the measured temperature can be loaded. The storing in step m) can take place in a memory of a control device for controlling the ultrasonic sensors.

In a development of the method of the present invention, the method comprises the step of: n) detecting an alignment error of the first ultrasonic sensor by analyzing a history of the correction values ascertained in step d). Additionally or alternatively, the method comprises the step of: o) detecting an alignment error of the second ultrasonic sensor by analyzing a history of the correction values ascertained in step e). Advantageously, the detection of the alignment error can be used to determine whether repair of the ultrasonic-sensor row is necessary.

The alignment error can occur, for example, due to unwanted mechanical action on the first ultrasonic sensor and/or the second ultrasonic sensor, for example due to an accident.

The analysis of the history of the correction values ascertained in step d) can be an analysis as to whether the values of the correction values ascertained in step d) have a jump in the history. The analysis of the history of the correction values ascertained in step e) can be an analysis as to whether the values of the correction values ascertained in step e) have a jump in the history.

The history of the correction values ascertained in step d) and/or the history of the correction values ascertained in step e) can each comprise 20 to 100 correction values.

According to an example embodiment of the present invention, the method can comprise the step of: s) outputting a warning if an alignment error is detected in step n) and/or in step o).

A vehicle according to the present invention, in particular a motor vehicle, comprises an ultrasound-based driver assistance system, in particular in the form of an ultrasound-based parking aid, which is designed to carry out a method described above. The ultrasound-based driver assistance system can comprise a control device which is designed to carry out the method described above.

Possible exemplary embodiments of the present invention will be explained below with reference to the figures.

### BRIEF DESCRIPTION OF THE DRAWINGS

FIG. 1 is a schematic plan view of a vehicle having an ultrasound-based driver assistance system which comprises an ultrasonic-sensor row.

FIG. 2 is a schematic plan view of two ultrasonic sensors of the ultrasonic-sensor row of FIG. 1 and an object having a punctiform reflection characteristic.

FIG. 3 is a schematic plan view of two ultrasonic sensors of the ultrasonic-sensor row of FIG. 1 and an object having a linear reflection characteristic.

FIG. 4 is another schematic plan view of the two ultrasonic sensors of FIG. 3.

FIG. 5 is a schematic plan view of an ultrasonic sensor of the ultrasonic-sensor row of FIG. 1.

FIG. 6 is an exemplary sequence of a method for the calibration of the ultrasonic sensors of the ultrasonic-sensor row of FIG. 1, according to an example embodiment of the present invention.

### DETAILED DESCRIPTION OF EXAMPLE EMBODIMENTS

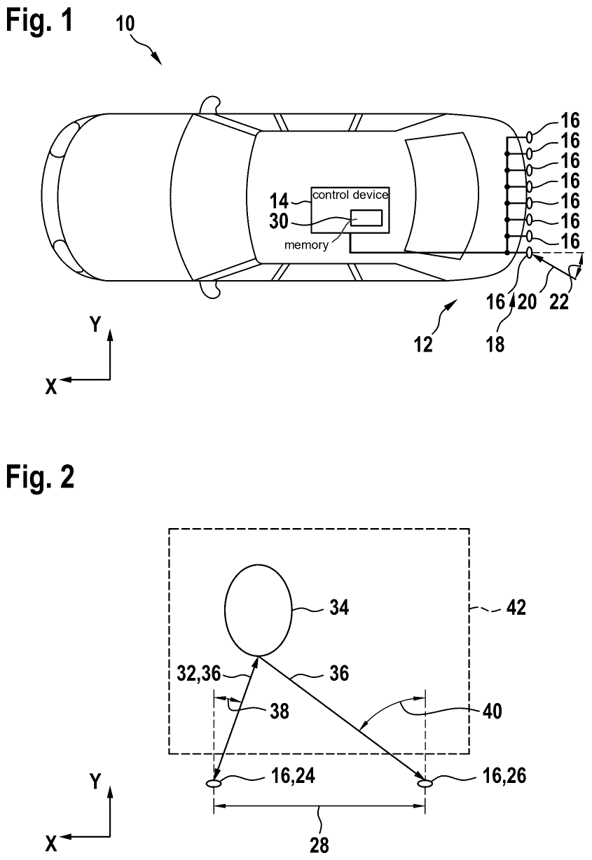

FIG. 1 shows a vehicle 10 having an ultrasound-based driver assistance system 12. The ultrasound-based driver assistance system 12 has a control device 14 and eight ultrasonic sensors 16. The ultrasonic sensors 16 are connected to the control device 14 with regard to signaling.

The ultrasound-based driver assistance system 12 is in the form of an ultrasound-based parking aid. The ultrasonic sensors 16 are arranged at a rear of the vehicle 10. The ultrasonic sensors 16 form an ultrasonic-sensor row 18.

Each ultrasonic sensor 16 is designed to emit an ultrasonic pulse and to detect an echo 20 of the ultrasonic pulse; an example of such an echo is shown in FIG. 1. Detecting the echo 20 comprises detection of an azimuth angle 22 of the echo 20. The azimuth angle 22 can be used to localize an object in the x-y plane spanned by a longitudinal direction and a transverse direction of the vehicle 10.

The ultrasound-based driver assistance system 12 is designed to carry out a method for the calibration of the azimuth angle of each ultrasonic sensor 16 of the ultrasonic-sensor row 18.

FIG. 2 shows, by way of example, two ultrasonic sensors 16 of the ultrasound-based driver assistance system 12 during the carrying out of the method for the calibration of the azimuth angles. Shown are a first ultrasonic sensor 24 and a second ultrasonic sensor 26 of the ultrasonic-sensor row 18.

A distance 28 between the first ultrasonic sensor 24 and the second ultrasonic sensor 26 is specified and stored in a memory 30 of the control device 14.

The first ultrasonic sensor 24 emits an ultrasonic pulse 32. The ultrasonic pulse 32 hits an object 34 in the form of a lamppost and is reflected by the object 34 as an echo 36.

The first ultrasonic sensor 24 detects the echo 36. The detecting of the echo 36 by means of the first ultrasonic sensor 24 comprises detection of an azimuth angle 38 of the echo 36 and the recording of a duration of a time period between emission of the ultrasonic pulse 32 and the receiving of the echo 36 by means of the first ultrasonic sensor 24.

The second ultrasonic sensor 26 detects the echo 36. The detecting of the echo 36 by means of the second ultrasonic sensor 26 comprises detection of an azimuth angle 40 of the echo 36 and the recording of a duration of a time period between emission of the ultrasonic pulse 32 and the receiving of the echo 36 by means of the second ultrasonic sensor 26.

On the basis of a comparison of echo lengths of the echoes 36 detected by means of the first and second ultrasonic sensors 24, 26, the control device 14 ascertains a reflection characteristic of the object 34 in the x-y plane. The object 34 in the form of the lamppost has a punctiform reflection characteristic.

On the basis of a history of echoes previously detected by means of the first and second ultrasonic sensors 24, 26, the control device 14 ascertains whether the object 34 has a multi-reflective reflection characteristic. The multi-reflective reflection characteristic is ascertained when a relatively large number of echoes following one another closely in time and/or an increased pulse width of the echoes is ascertained in the history. The multi-reflective reflection characteristic can be ascertained by using statistical methods, for example in the history. In the presented exemplary embodiment, the history comprises twenty values. However, ten to two hundred values are also possible. The history is stored in the memory 30.

Since the probability of ambiguities is high in the case of a multi-reflective reflection characteristic, the control device 14 aborts the method for calibration when a multi-reflective reflection characteristic is ascertained. In the presented exemplary embodiment, no multi-reflective reflection characteristic is ascertained.

By analyzing the echoes 36 detected by means of the first and second ultrasonic sensors 24, 26, the control device 14 ascertains whether a disturbance is present. If disturbances occur due to noise, ground echoes, object echoes or similar echoes, the determination of the echo lengths can be distorted. Errors in echo length determination have a direct impact on the method for calibration if they are not filtered.

The control device 14 can identify undisturbed echoes by correlating the received echo with the transmitted ultrasonic pulse. For example, all echoes from the object 34 can be checked. If the correlation is smaller than a certain distance-dependent threshold, the measurement data corresponding to the echo can be discarded. Optionally, other methods can also be used to analyze the peak shapes after the adjusted filtering, in order to determine the degree of disturbance.

The control device 14 aborts the method for calibration if a disturbance is ascertained. In the presented exemplary embodiment, no disturbance is ascertained.

On the basis of the recorded durations of the time periods between the emission of the ultrasonic pulse 32 and the receiving of the echoes 36, the control device 14 ascertains a distance of the object 34 from the first ultrasonic sensor 24 and a distance of the object 34 from the second ultrasonic sensor 26.

On the basis of the distances of the object 34 from the first and second ultrasonic sensors 24, 26 and the distance 28 between the first ultrasonic sensor 24 and the second ultrasonic sensor 26, the control device 14 ascertains a position of the object 34 by trilateration.

The control device 14 checks whether the ascertained position of the object 34 is within a specified permissible range 42. The permissible range 42 is a range within which an azimuth angle can be reliably detected by means of the first ultrasonic sensor 24 and the second ultrasonic sensor 26. The control device 14 aborts the method for calibration if the object 34 is outside the specified permissible range 42. In the presented initial example, the object 34 is located within the specified permissible range 42.

Optionally, a statistical evaluation of follow-up measurements can additionally be carried out. Entities whose positional dispersion is greater than a certain threshold can then be excluded.

Ambiguities in the pairing of direct echo and cross echo can significantly influence the position of the reflection. If several pairing possibilities are identified, they can be excluded.

The control device 14 ascertains a target azimuth angle for the echo 36 detected by means of the first ultrasonic sensor 24 and a target azimuth angle for the echo 36 detected by means of the second ultrasonic sensor 26, on the basis of the position of the object 34.

The control device 14 ascertains a correction value for the detecting of the azimuth angle 38 by means of the first ultrasonic sensor 24 by subtracting the azimuth angle 38 of the echo 36 that was detected by means of the first ultrasonic sensor 24 from the target azimuth angle of the echo 36 for the first ultrasonic sensor 24. The control device 14 ascertains a correction value for the detecting of the azimuth angle 40 by means of the second ultrasonic sensor 26 by subtracting the azimuth angle 40 of the echo 36 that was detected by means of the second ultrasonic sensor 26 from the target azimuth angle of the echo 36 for the second ultrasonic sensor 26.

In addition, the ultrasound-based driver assistance system 12 detects a temperature at which the correction values are ascertained. The temperature is stored in the memory 30 together with the correction value for the first ultrasonic sensor 24 and the correction value for the second ultrasonic sensor 26.

The control device 14 is designed to analyze a history of the correction values for the first ultrasonic sensor 24 and the second ultrasonic sensor 26 for the presence of an alignment error of the ultrasonic sensors 24, 26. For example, an alignment error can be ascertained on the basis of a sudden jump in a value of the correction values.

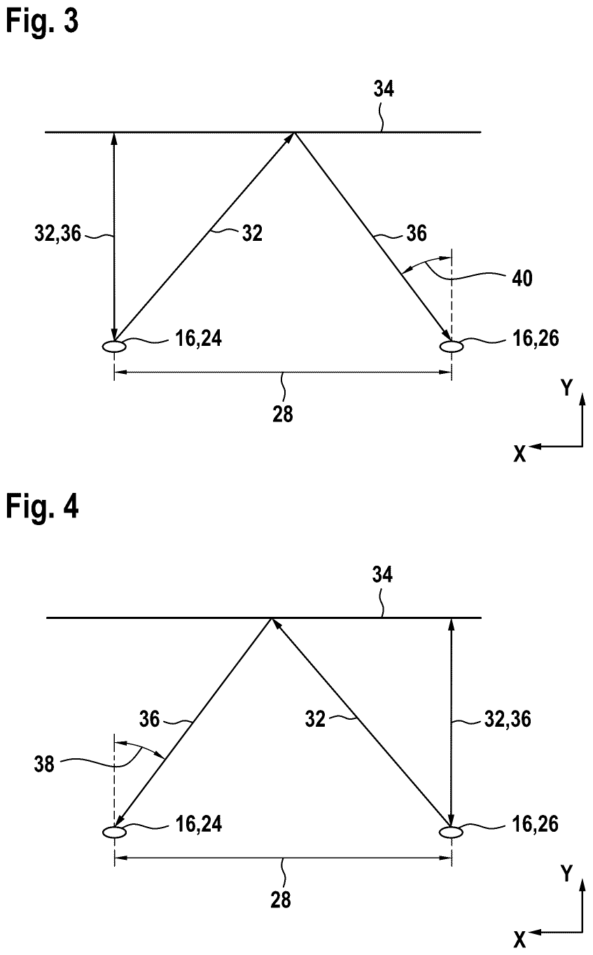

FIGS. 3 and 4 show the two ultrasonic sensors 16 of FIG. 2 during the carrying out of a variant of the method for the calibration of the azimuth angles of FIG. 2, wherein the same reference signs are used for identical and functionally equivalent elements and in this respect reference can be made to the above explanations regarding the exemplary embodiment of FIG. 2, so that essentially the existing differences are addressed.

In the initial example of FIGS. 3 and 4, the object 34 is in the form of a wall. The wall 34 has a linear reflection characteristic in the azimuthal plane of the ultrasonic sensors 16.

In FIG. 3, the first ultrasonic sensor 24 emits the ultrasonic pulse 32. The ultrasonic pulse 32 hits the object 34 and is reflected by the object 34 as an echo 36. The first ultrasonic sensor 24 detects the echo 36 with an azimuth angle, and the second ultrasonic sensor 26 detects the echo 36 with an azimuth angle 40. The detected azimuth angle of the first ultrasonic sensor 24 and the detected azimuth angle 40 of the second ultrasonic sensor 26 differ from one another such that the control device 14 ascertains a linear reflection characteristic of the object 34.

In the presented exemplary embodiment, the control device 14 checks whether the ascertained linear reflection characteristic is correct. For this purpose, the second ultrasonic sensor 26 emits the ultrasonic pulse 32. The ultrasonic pulse 32 hits the object 34 and is reflected by the object 34 as an echo 36. The first ultrasonic sensor 24 and the second ultrasonic sensor 26 each detect the echo 36 with an azimuth angle. The detected azimuth angle 38 of the first ultrasonic sensor 24 and the detected azimuth angle of the second ultrasonic sensor 26 differ from one another such that the control device 14 confirms the linear reflection characteristic of the object 34.

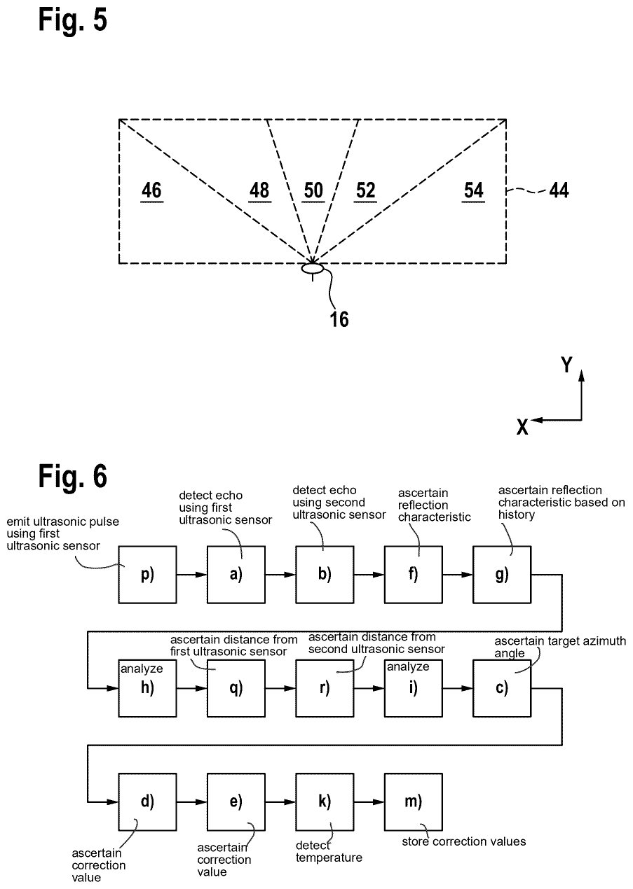

FIG. 5 shows, by way of example, an ultrasonic sensor 16 of the ultrasonic-sensor row 18. For each ultrasonic sensor 16 of the ultrasonic-sensor row 18, a division of a sensor range 44 of the ultrasonic sensor 16 into angular intervals 46, 48, 50, 52, 54 can be stored in the memory 30 of the control device 14. For example, the angular interval 46 can extend from an azimuth angle of −90° to −45°, the angular interval 48 from −45° to −10°, the angular interval 50 from −10° to +10°, the angular interval 52 from an azimuth angle of +10° to +45° and the angular interval 54 from +45° to +90°. The control device can be designed to ascertain a separate correction value for each angular interval 46, 48, 50, 52, 54.

FIG. 6 shows an exemplary sequence of a method for the calibration of the azimuth angles of the first and second ultrasonic sensors 24, 26 of FIG. 2.

The method comprises the steps of: p) emitting an ultrasonic pulse 36 by means of the first ultrasonic sensor 24; a) detecting an echo 36 of the ultrasonic pulse 36 from an object 34 by means of the first ultrasonic sensor 24, the detecting of the echo 36 by means of the first ultrasonic sensor 24 comprising detection of an azimuth angle 38 of the echo 36 and recording of a duration of a time period between emission of the ultrasonic pulse 36 and the receiving of the echo 36 by means of the first ultrasonic sensor 24; b) detecting the echo 36 of the ultrasonic pulse 32 from the object 34 by means of the second ultrasonic sensor 26, the detecting of the echo 36 by means of the second ultrasonic sensor 26 comprising detection of an azimuth angle 40 of the echo 36 and recording of a duration of a time period between emission of the ultrasonic pulse 32 and the receiving of the echo 36 by means of the second ultrasonic sensor 26; f) ascertaining a reflection characteristic of the object 34 in an azimuthal plane of the ultrasonic sensors 16 on the basis of the echo 36 detected by means of the first ultrasonic sensor 24 and the echo 36 detected by means of the second ultrasonic sensor 26; g) ascertaining a reflection characteristic of the object 34 on the basis of a history of echoes 36 detected by means of the first ultrasonic sensor 24 and on the basis of a history of echoes 36 detected by means of the second ultrasonic sensor 26; h) analyzing the echo 36 detected by means of the first ultrasonic sensor 24 and/or the echo 36 detected by means of the second ultrasonic sensor 26 as to whether a disturbance is present; q) ascertaining a distance of the object 34 from the first ultrasonic sensor 24 on the basis of the echo 36 detected by means of the first ultrasonic sensor 24; r) ascertaining a distance of the object 34 from the second ultrasonic sensor 26 on the basis of the echo 36 detected by means of the second ultrasonic sensor 26; i) checking whether the object 34 is within a specified permissible range 42; c) ascertaining a target azimuth angle of the echo 36 for the first ultrasonic sensor 24 and a target azimuth angle of the echo 36 for the second ultrasonic sensor 26 on the basis of a position determination of the object 34 by trilateration; d) ascertaining a correction value for the detecting of the azimuth angle 38 by means of the first ultrasonic sensor 24 on the basis of the ascertained target azimuth angle of the echo 36 for the first ultrasonic sensor 24; e) ascertaining a correction value for the detecting of the azimuth angle 40 by means of the second ultrasonic sensor 26 on the basis of the ascertained target azimuth angle of the echo 36 for the second ultrasonic sensor 26; k) detecting a temperature while steps a) and b) are being carried out, and m) storing the correction values ascertained in steps d) and e) and the temperature detected in step k).

1-10. (canceled)

11. A method for calibration of azimuth angles of ultrasonic sensors of an ultrasonic-sensor row, wherein the ultrasonic-sensor row includes a first ultrasonic sensor and a second ultrasonic sensor, the method comprising the following steps:
a) detecting an echo of an ultrasonic pulse from an object using the first ultrasonic sensor, the detecting of the echo using the first ultrasonic sensor including detection of an azimuth angle of the echo;
b) detecting an echo of an ultrasonic pulse from the object using the second ultrasonic sensor, the detecting of the echo using the second ultrasonic sensor including detection of an azimuth angle of the echo;
c) ascertaining a target azimuth angle of the echo for the first ultrasonic sensor and a target azimuth angle of the echo for the second ultrasonic sensor based on a position determination of the object by trilateration;
d) ascertaining a correction value for the detecting of the azimuth angle using the first ultrasonic sensor based on the ascertained target azimuth angle of the echo for the first ultrasonic sensor; and
e) ascertaining a correction value for the detecting of the azimuth angle using the second ultrasonic sensor based on the ascertained target azimuth angle of the echo for the second ultrasonic sensor.

12. The method according to claim 11, wherein the method further comprises the following steps:
f) ascertaining a reflection characteristic of the object based on the echo detected using the first ultrasonic sensor and the echo detected using the second ultrasonic sensor;
wherein at least steps d) and e) are carried out when a punctiform or linear reflection characteristic is ascertained in step f), and at least steps d) and e) are not carried out when a punctiform or linear reflection characteristic is not ascertained in step f).

13. The method according to claim 11, further comprising the following step:
g) ascertaining a reflection characteristic of the object based on a history of echoes detected using the first ultrasonic sensor and based on a history of echoes detected using he second ultrasonic sensor;
wherein at least steps d) and e) are carried out when a multi-reflective reflection characteristic is not ascertained in step g), and at least steps d) and e) are not carried out when a multi-reflective reflection characteristic is ascertained in step g).

14. The method according to claim 11, further comprising the following step:
h) analyzing the echo detected using the first ultrasonic sensor and/or the echo detected using the second ultrasonic sensor, as to whether a disturbance is present;
wherein at least steps d) and e) are carried out when a disturbance is not ascertained in step h), and at least steps d) and e) are not carried out when a disturbance is ascertained in step h).

15. The method according to claim 11, further comprising the following step:
i) analyzing the position determination of the object of step c) as to whether the object is within a specified permissible range;
wherein at least steps d) and e) are carried out when the analysis of step i) shows that the object is within the specified permissible range, and at least steps d) and e) are not carried out when the analysis of step i) shows that the object is outside the specified permissible range.

16. The method according to claim 11, wherein: (i) the correction value is ascertained in step d) by subtracting the azimuth angle of the echo that was detected using the first ultrasonic sensor from the target azimuth angle of the echo for the first ultrasonic sensor, and/or (ii) the correction value is ascertained in step e) by subtracting the azimuth angle of the echo that was detected using the second ultrasonic sensor from the target azimuth angle of the echo for the second ultrasonic sensor.

17. The method according to claim 11, wherein: (i) at least steps a) to e) are carried out several times, wherein the correction value is ascertained in step d) by calculating a median value or a mean of differences between the azimuth angles of the echoes that were detected using the first ultrasonic sensor and the target azimuth angles of the echoes for the first ultrasonic sensor, and/or (ii) the correction value is ascertained in step e) by calculating a median value or a mean of differences between the azimuth angles of the echoes that were detected using the second ultrasonic sensorand the target azimuth angles of the echoes for the second ultrasonic sensor.

18. The method according to claim 11, further comprising the following steps:
k) detecting a temperature while at least one of steps a) to e) is being carried out; and
m) storing the correction values ascertained in steps d) and e) and the temperature detected in step k).

19. The method according to claim 11, further comprising the following:
n) detecting an alignment error of the first ultrasonic sensor by analyzing a history of the correction values ascertained in step d), and/or
o) detecting an alignment error of the second ultrasonic sensorby analyzing a history of the correction values ascertained in step e).

20. A motor vehicle, comprising:
an ultrasound-based driver assistance system configured to calibrate azimuth angles of ultrasonic sensors of an ultrasonic-sensor row, wherein the ultrasonic-sensor row includes a first ultrasonic sensor and a second ultrasonic sensor, the altrasound-based driver assistance system configured to perform the following steps:
a) detecting an echo of an ultrasonic pulse from an object using the first ultrasonic sensor, the detecting of the echo using the first ultrasonic sensor including detection of an azimuth angle of the echo;
b) detecting an echo of an ultrasonic pulse from the object using the second ultrasonic sensor, the detecting of the echo using the second ultrasonic sensor including detection of an azimuth angle of the echo;
c) ascertaining a target azimuth angle of the echo for the first ultrasonic sensor and a target azimuth angle of the echo for the second ultrasonic sensor based on a position determination of the object by trilateration;
d) ascertaining a correction value for the detecting of the azimuth angle using the first ultrasonic sensor based on the ascertained target azimuth angle of the echo for the first ultrasonic sensor; and
e) ascertaining a correction value for the detecting of the azimuth angle using the second ultrasonic sensor based on the ascertained target azimuth angle of the echo for the second ultrasonic sensor.
